(19) United States
(12) Patent Application Publication
(10) Pub. No.: US 2019/0109506 A1
(43) Pub. Date: Apr. 11, 2019

(54) STATOR OF ROTARY ELECTRIC MACHINE AND INSULATION PAPER

(71) Applicant: HONDA MOTOR CO., LTD., Tokyo (JP)

(72) Inventors: Tadashi YAMAGUCHI, Saitama (JP); Ryutaro KATO, Saitama (JP); Tomohiro KOTA, Saitama (JP); Yusuke KAWANO, Saitama (JP); Takashi SUGAWARA, Saitama (JP); Kazuyuki OHTA, Saitama (JP); Taisuke MARUYAMA, Saitama (JP); Tadamichi SASAKI, Saitama (JP)

(73) Assignee: HONDA MOTOR CO., LTD., Tokyo (JP)

(21) Appl. No.: 16/149,349

(22) Filed: Oct. 2, 2018

(30) Foreign Application Priority Data
Oct. 5, 2017 (JP) 2017-195407

(51) Int. Cl. H02K 3/34; H02K 1/16; H02K 3/12

(52) U.S. Cl. CPC H02K 3/345; H02K 3/12; H02K 1/16

(57) ABSTRACT

There is provided a stator of a rotary electric machine which includes a stator core including a plurality of slots in a circumferential direction thereof, a coil inserted into each of the slots, and an insulation paper disposed between each of the slots and the coil. The insulation paper includes a first adhesive layer provided on one surface of the insulation paper and a second adhesive layer provided on the other surface of the insulation paper. The first adhesive layer and the second adhesive layer are disposed to be displaced from each other when the insulation paper located on one side in the circumferential direction is viewed from the coil inserted into the slot.

### CROSS-REFERENCE TO RELATED APPLICATIONS

The present application claims the benefit of priority of Japanese Patent Application No. 2017-195407, filed on Oct. 5, 2017, the content of which is incorporated herein by reference.

### TECHNICAL FIELD

The present invention relates to a stator of a rotary electric machine and an insulation paper.

### BACKGROUND ART

As illustrated in FIG. 12, a stator of a rotary electric machine includes a stator core 31 and a coil 32. The stator core 31 includes a plurality of teeth 33 disposed in a circumferential direction (direction of an arrow B) thereof which are projected inward in a radial direction (direction of an arrow A) of the stator core 31. A slot 34 is formed between adjacent teeth 33. The coil 32 is inserted into the slot 34. An insulation paper 35 is provided between the coil 32 and a surface 34s defining the slot 34 in a state of being folded to surround the coil 32 along an axial direction of the rotary electric machine (see JP-A-2016-52226). Adhesive layers 36 are provided on both surfaces of an area of the insulation paper 35 surrounding the coil 32 (see JP-A-2017-77095). The coil 32 and the insulation paper 35 are fixed by the adhesive layer 36 formed on one surface of the insulation paper 35, and the insulation paper 35 and the surface 34s defining the slot 34 are fixed by the adhesive layer 36 formed on the other surface of the insulation paper 35. Accordingly, detachment of the insulation paper 35 can be prevented, and the coil 32 can be fixed to the stator core 31.

In the above-described insulation paper 35, when the adhesive layer 36 is provided over the entire area surrounding the coil 32 in the slot 34, the coil 32, the insulation paper 35 and the stator core 31 can be reliably integrated, but on the other hand, noise vibration (NV) characteristics of the rotary electric machine is reduced since rigidity of the stator 30 increases. That is, since vibration generated in the coil 32 propagates linearly in the circumferential direction during operation of the rotary electric machine as indicated by a wavy line arrow in FIG. 13, there is a problem that the vibration is easy to propagate to the stator core 31.

### SUMMARY

Accordingly, an object of the present invention is to provide a stator of a rotary electric machine and an insulation paper which are capable of suppressing the propagation of vibration.

According to a first aspect of the present invention, there is provided a stator of a rotary electric machine (e.g., a stator 10 in embodiments to be described below) including:

a stator core (e.g., a stator core 11 in the embodiments) including a plurality of slots., slots 15 in the embodiments) in a circumferential direction thereof;

a coil (e.g., a coil 12 in the embodiments) inserted into each of the slots; and

an insulation paper (e.g., an insulation paper 16 in the embodiments) disposed between each of the slots and the coil,

wherein the insulation paper includes a first adhesive layer (e.g., a first adhesive layer 41 in the embodiments) provided on one surface of the insulation paper and a second adhesive layer (e.g., a second adhesive layer 42 in the embodiments) provided on the other surface of the insulation paper, and

wherein the first adhesive layer and the second adhesive layer are disposed to be displaced from each other when the insulation paper located on one side in the circumferential direction is viewed from the coil inserted into the slot.

According to a second aspect of the present invention, in the stator of the first aspect,

the first adhesive layer and the second adhesive layer are disposed not to overlap each other when the insulation paper located on the one side in the circumferential direction is viewed from the coil inserted into the slot.

According to a third aspect of the present invention, in the stator of the first or second aspect,

the first adhesive layer and the second adhesive layer are disposed to be displaced from each other when the insulation paper located on the other side in the circumferential direction is viewed from the coil inserted into the slot.

According to a fourth aspect of the present invention, in the stator of the third aspect,

the first adhesive layer and the second adhesive layer are disposed not to overlap each other when the insulation paper located on the other side in the circumferential direction is viewed from the coil inserted into the slot.

According to a fifth aspect of the present invention, there is provided an insulation paper (e.g., an insulation paper 16 in the embodiments) to be disposed between a slot (e.g., a slot 15 in the embodiments) formed in a stator core (e.g., a stator core 11 in the embodiments) and a coil (e.g., a coil 12 in the embodiments) inserted into the slot, the insulation paper including:

a first adhesive layer (e.g., a. first adhesive layer 41 in the embodiments) provided on one surface of the insulation paper and a second adhesive layer (e.g., a second adhesive layer 42 in the embodiments) provided on the other surface of the insulation paper, wherein the first adhesive layer and the second adhesive layer are disposed to be displaced from each other.

According to a sixth aspect of the present invention, in the insulation paper of the fifth aspect,

the first adhesive layer and the second adhesive layer are disposed not to overlap each other.

### Effects

According to the first aspect of the present invention, since the first adhesive layer and the second adhesive layer are disposed to be displaced from each other when the insulation paper located on one side in the circumferential direction is viewed from the coil inserted into the slot, a propagation path of vibration from the coil to the stator core on the one side in the circumferential direction of the slot cannot extend linearly in the circumferential direction from the coil and can be lengthened by an amount including a path along which the vibration propagates on the insulation paper in the radial direction and/or the axial direction. Since the vibration is attenuated as the propagation path is longer, the propagation of vibration from the coil to the stator core can be suppressed.

According to the second aspect of the present invention, since the first adhesive layer and the second adhesive layer do not overlap each other when the insulation paper located on the one side in the circumferential direction is viewed from the coil inserted into the slot, there is no path along which the vibration from the coil to the stator core propagates directly in the circumferential direction. That is, since there is no short propagation path, the propagation of vibration can be further suppressed.

According to the third aspect of the present invention, since the first adhesive layer and the second adhesive layer are disposed to be displaced from each other when the insulation paper located on the other side in the circumferential direction is viewed from the coil inserted into the slot, the propagation path of vibration from the coil to the stator core on the other side in the circumferential direction of the slot can be also lengthened, so that the propagation of vibration from the coil to the stator core can be further suppressed.

According to the fourth aspect of the present invention, since the first adhesive layer and the second adhesive layer do not overlap each other when the insulation paper located on the other side in the circumferential direction is viewed from the coil inserted into the slot, and since there is no path along which the vibration from the coil to the stator core propagates directly in the circumferential direction, the propagation of vibration can be further suppressed.

According to the fifth aspect of the present invention, since the first adhesive layer provided on one surface of the insulation paper and the second adhesive layer provided on the other surface of the insulation paper are disposed to be displaced from each other, vibration via the adhesive layer of the insulation paper can be suppressed.

According to the sixth aspect of the present invention, since the first adhesive layer and the second adhesive layer are disposed not to overlap each other, vibration via the adhesive layer of the insulation paper can be further suppressed.

### BRIEF DESCRIPTION OF THE DRAWINGS

FIG. 1 is a radial sectional view of a stator of a rotary electric machine according to an embodiment of the present invention.

FIG. 2 is a partially expanded view of the stator in which teeth arranged in a circumferential direction are expanded linearly.

FIG. 3 is a perspective view of an insulation paper according to a first embodiment.

FIG. 4 is a partially expanded view of a stator in which an insulation paper according to a second embodiment is disposed.

FIG. 5 is a perspective view of the insulation paper according to the second embodiment.

FIG. 6A is a schematic view illustrating a propagation path of vibration from a coil to teeth in the insulation paper according to the first embodiment, and FIG. 6B is a schematic view illustrating a propagation path of vibration from a coil to teeth in the insulation paper according to the second embodiment.

FIG. 7 is a perspective view of an insulation paper according to a third embodiment.

FIG. 8 is a perspective view of an insulation paper according to a fourth embodiment.

FIG. 9 is a perspective view of an insulation paper according to a fifth embodiment.

FIG. 10 is a perspective view of an insulation paper according to a sixth embodiment.

FIG. 11 is a perspective view of an insulation paper according to a seventh embodiment.

FIG. 12 is a partially expanded view of a stator in which teeth arranged in a circumferential direction are expanded linearly in a related-art stator.

FIG. 13 is a schematic view illustrating a propagation path of vibration from a coil to the teeth in a configuration illustrated in FIG. 12.

### DETAILED DESCRIPTION OF EMBODIMENT

Hereinafter, embodiments of the present invention are described with reference to the drawings. It is assumed that the drawings are seen in directions of reference numerals.

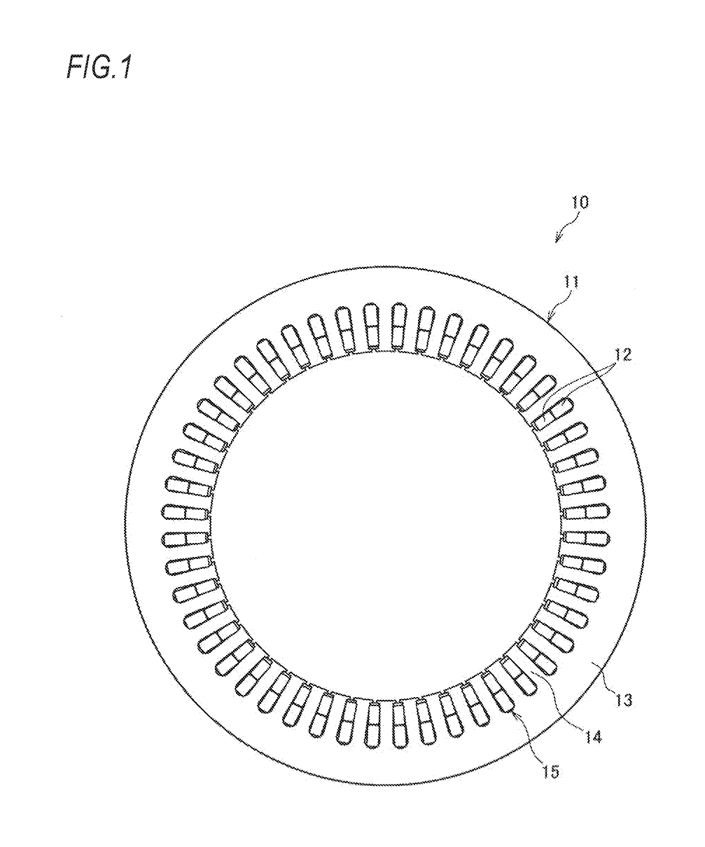

FIG. 1 is a radial sectional view of a stator of a rotary electric machine according to an embodiment of the present invention. A stator 10 illustrated in FIG. 1 is combined with a rotor (not illustrated) to be provided inside the stator 10 to constitute the rotary electric machine. The rotary electric machine is configured such that the rotor is rotated by energizing a coil 12 wound around teeth 14 of the stator 10. The rotary electric machine may be mounted on a vehicle as a drive source thereof.

The stator 10 includes a stator core 11 and the coil 12. The stator core 11 is configured by laminating a plurality of steel plates. Each steel sheet is a plate-like member including an annular stator yoke 13, a plurality of teeth 14 projected radially inward from the stator yoke 13 at equal intervals, and slots 15 formed at equal intervals in a circumferential direction between adjacent teeth 14. The steel plates are formed by punching an electromagnetic steel plate. When laminating the plurality of steel plates, a plurality of slots 15 penetrating in an axial direction are formed in the stator core 11 at equal intervals in the circumferential direction. The coil 12 of three phases (U-phase,

V-phase, and NV-phase) wound around the plurality of teeth 14 by distributed winding are inserted into the slots 15.

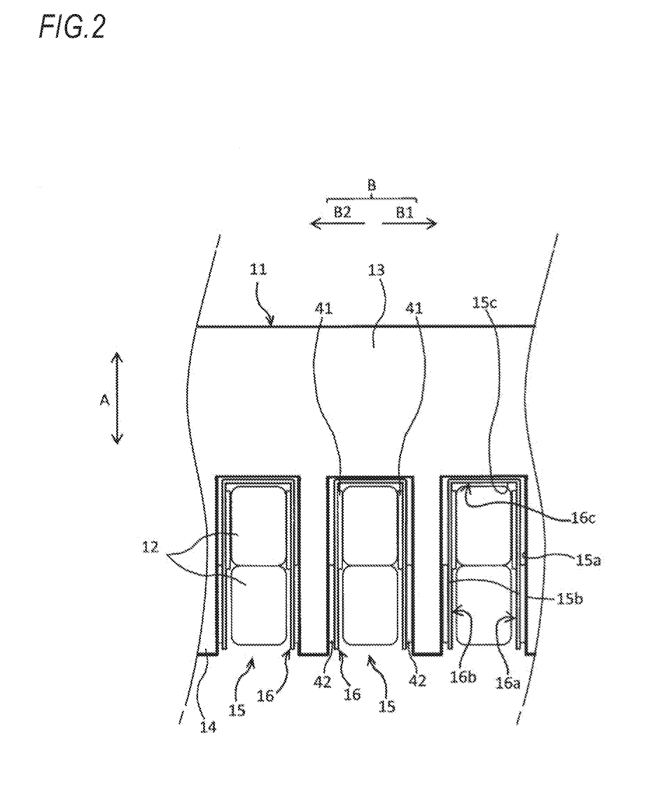

FIG. 2 is a partially expanded diagram of the stator in which teeth arranged in the circumferential direction are expanded linearly. As illustrated in FIG. 2, for example, two coils 12 having rectangular sections are disposed to overlap each other in the radial direction (direction of an arrow A) in each of the slots 15. An insulation paper 16 is disposed along an axial direction of the rotary electric machine between the coils 12 in the slot 15 and surfaces 15a, 15b, 15c defining the slot 15. The insulation paper 16 is disposed to surround the two coils 12 in the slot 15. A first adhesive layer 41 is provided on a part of one surface (a coil facing surface which faces the coil 12) of the insulation paper 16, and a second adhesive layer 42 is provided on a part of the other surface (a core facing surface which faces the stator core 11).

As illustrated in FIG. 2, the insulation paper 16 includes a first insulation portion 16a and a second insulation portion 16b located between two side surfaces 15a, 15b facing each other in the circumferential direction (direction of an arrow B) and the coil 12, and a third insulation portion 16c located between a bottom surface 15c of the slot 15 and the coil 12. The first insulation portion 16a is located on one side in the circumferential direction (direction of an arrow B1), and the second insulation portion 16b is located on the other side in the circumferential direction (direction of an arrow B2) as viewed from the coil 12 inserted into the slot 15. The first adhesive layer 41 and the second adhesive layer 42 are provided respectively on two surfaces of the first insulation portion 16a, and the first adhesive layer 41 and the second adhesive layer 42 are provided respectively on two surfaces of the second insulation portion 16b.

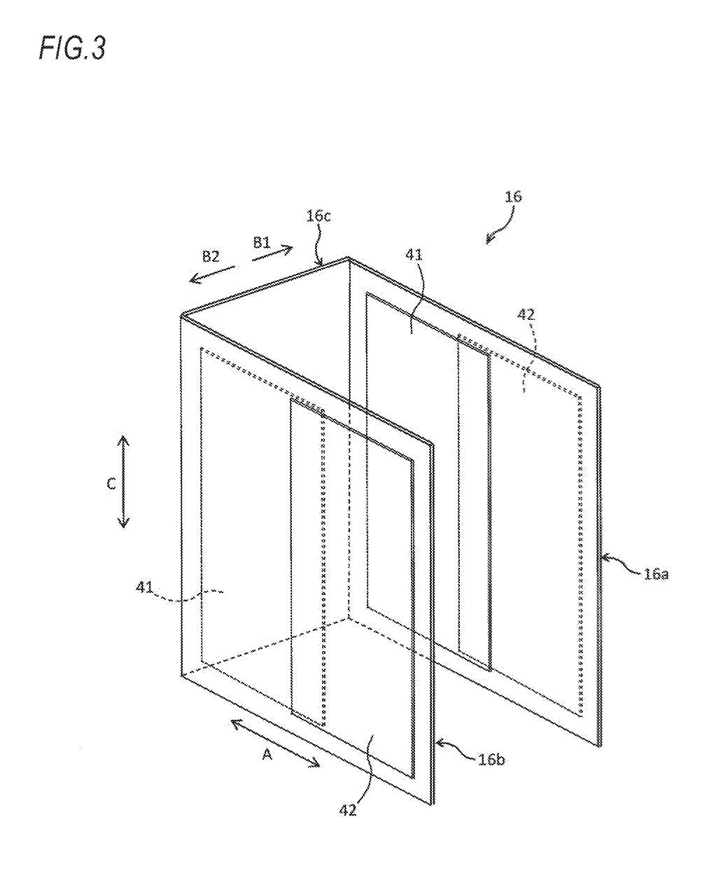

FIG. 3 is a perspective view of the insulation paper 16 according to a first embodiment. As illustrated in FIGS. 2 and 3, the first adhesive layer 41 and the second adhesive layer 42 provided on the first insulation portion 16a each have a rectangular shape in which a side in the axial direction (direction of the arrow C) is longer than a side in the radial direction (direction of the arrow A), and are disposed to be displaced from each other in the radial direction (direction of the arrow A) when the first insulation portion 16a is viewed from the coil 12 inserted into the slot 15. Similarly, the first adhesive layer 41 and the second adhesive layer 42 provided on the second insulation portion 16b each have a rectangular shape in which a side in the axial direction (direction of the arrow C) is longer than a side in the radial direction (direction of the arrow A), and are disposed to be displaced from each other in the radial direction (direction of the arrow A) when the second insulation portion 16b is viewed from the coil 12 inserted into the slot 15.

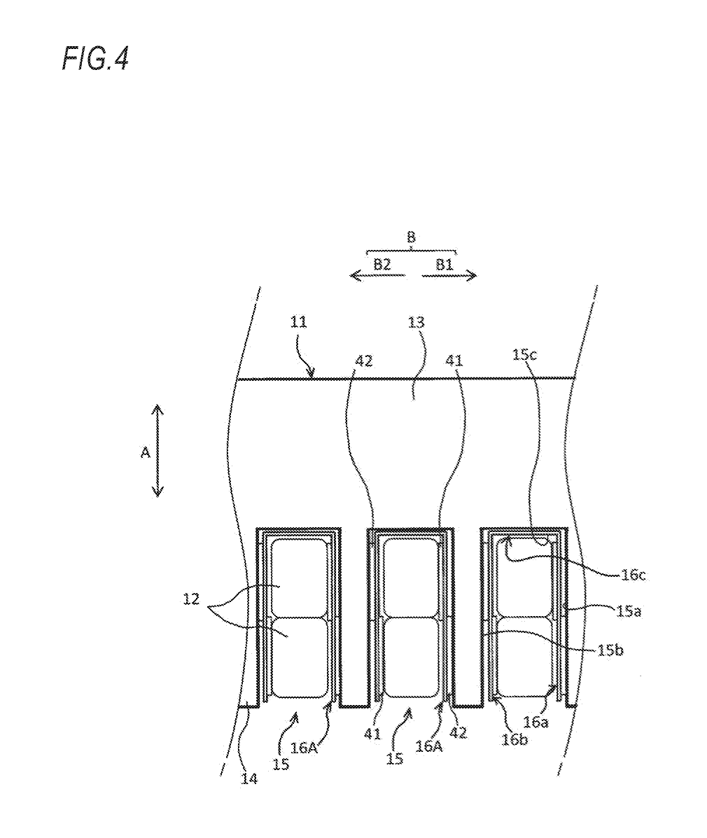

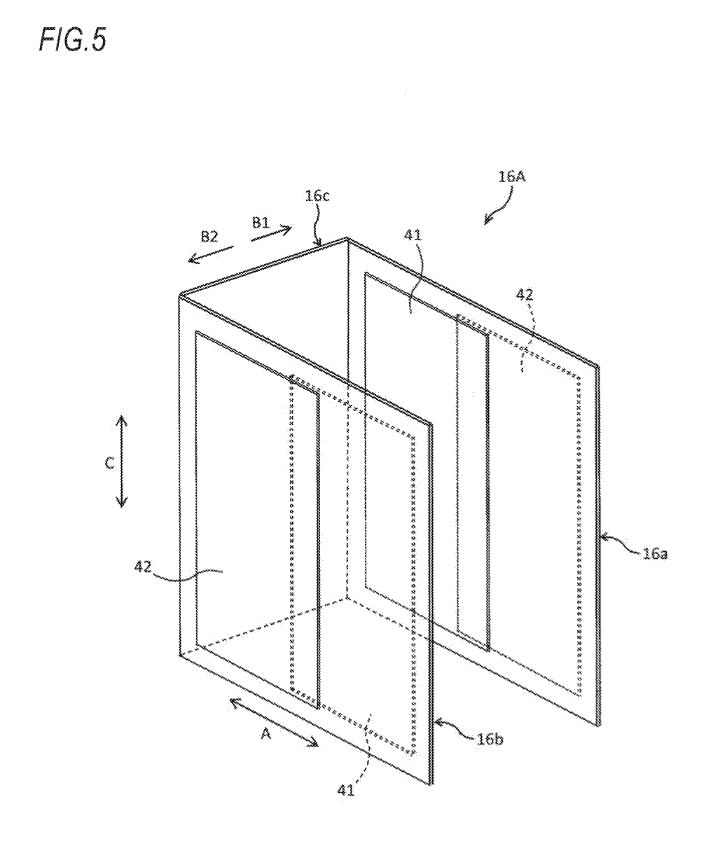

In the insulation paper 16 of the first embodiment illustrated in FIGS. 2 and 3, in both the first insulation portion 16a and the second insulation portion 16b, the first adhesive layer 41 disposed on the coil facing surface is disposed on an outer side in the radial direction (direction of the arrow A), and the second adhesive layer 42 disposed on the core facing surface is disposed on an inner side in the radial direction (direction of the arrow A). However, regardless of disposition of the first adhesive layer 41 and the second adhesive layer 42 illustrated in FIGS. 2 and 3, as illustrated in an insulation paper 16A according to the second embodiment of FIGS. 4 and 5, in the first insulation portion 16a, the first adhesive layer 41 disposed on the coil facing surface may be disposed on the outer side in the radial direction (direction of the arrow A), and the second adhesive layer 42 disposed on the core facing surface may be disposed on the inner side in the radial direction (direction of the arrow A), and in the second insulation portion 16b, the first adhesive layer 41 disposed on the coil facing surface may be disposed on the inner side in the radial direction (direction of the arrow A), and the second adhesive layer 42 disposed on the core facing surface may be disposed on the outer side in the radial direction (direction of the arrow A).

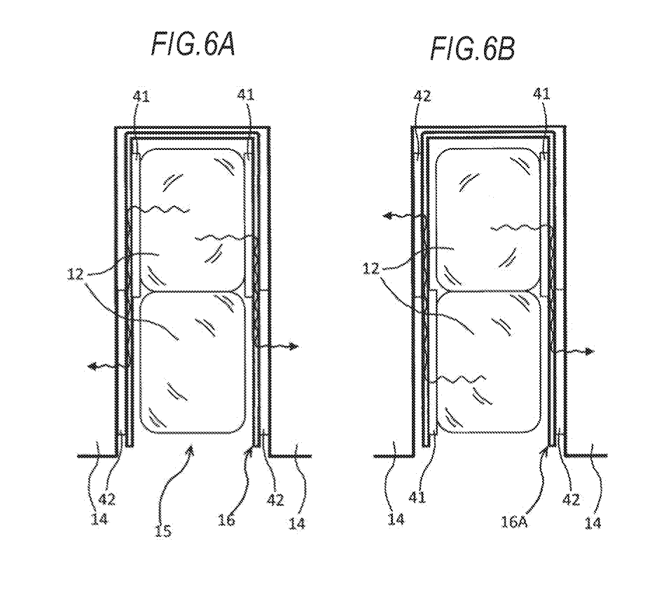

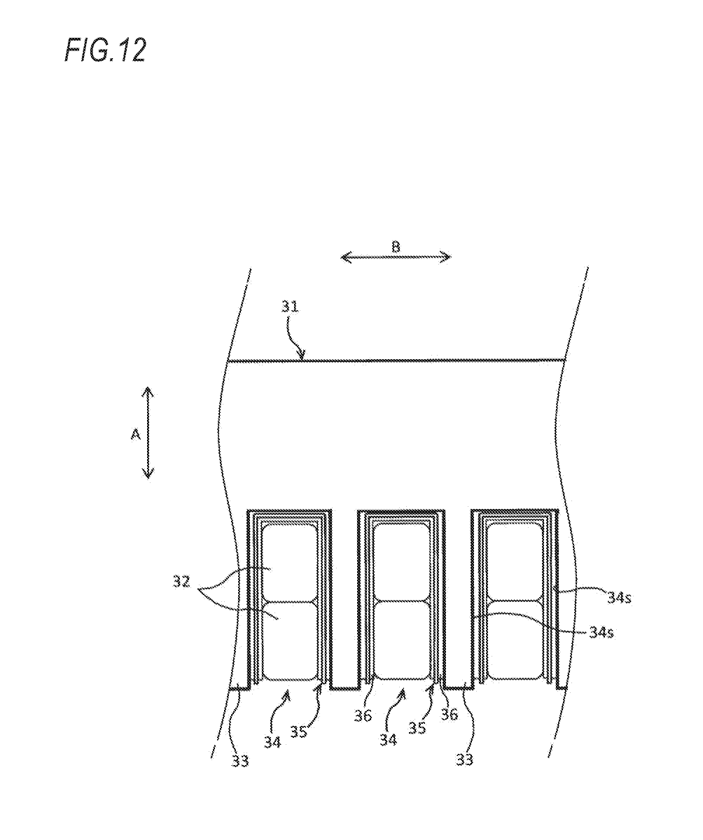

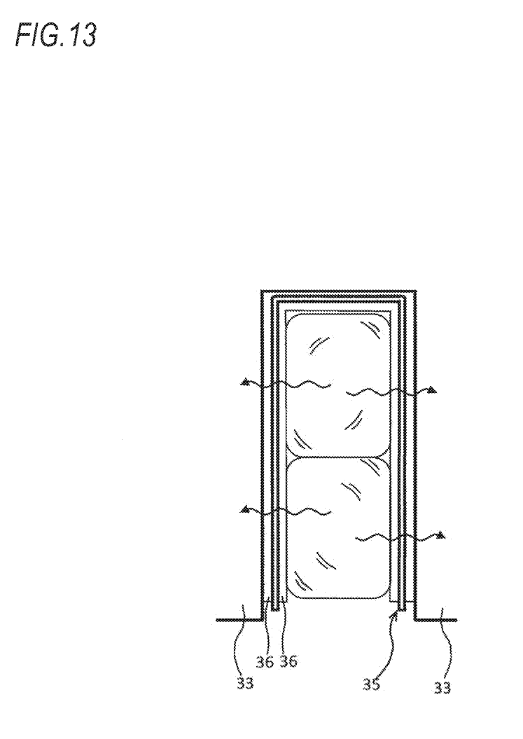

In either case, as indicated by a wavy line arrow in FIGS. 6A and 6B, a propagation path length of vibration to the teeth 14 which occurs in the coil 12 during operation of the rotary electric machine can be longer than a propagation path length in a configuration illustrated in FIGS. 12 and 13. Specifically, FIG. 6A is a schematic view illustrating a propagation path of vibration from the coil 12 to the teeth 14 in the insulation paper 16 according to the first embodiment illustrated in FIGS. 2 and 3, and FIG. 6B is a schematic view illustrating a propagation path of vibration from the coil 12 to the teeth 14 in the insulation paper 16A according to the second embodiment illustrated in FIGS. 4 and 5. That is, as illustrated in FIGS. 6A and 6B, the propagation path of vibration from the coil 12 to the teeth 14 cannot be a path which extends linearly in the circumferential direction from the coil 12, and can be lengthened by an amount including a path along which the vibration propagates on the insulation paper 16 in the radial direction. Since the vibration is attenuated as the propagation path is longer, the propagation of vibration from the coil 12 to the teeth 14 can be suppressed based on the deposition of the first adhesive layer 41 and the second adhesive layer 42 provided on the insulation paper 16 of the present embodiments. Accordingly, the rotary electric machine having good Noise Vibration (NV) characteristics can be obtained.

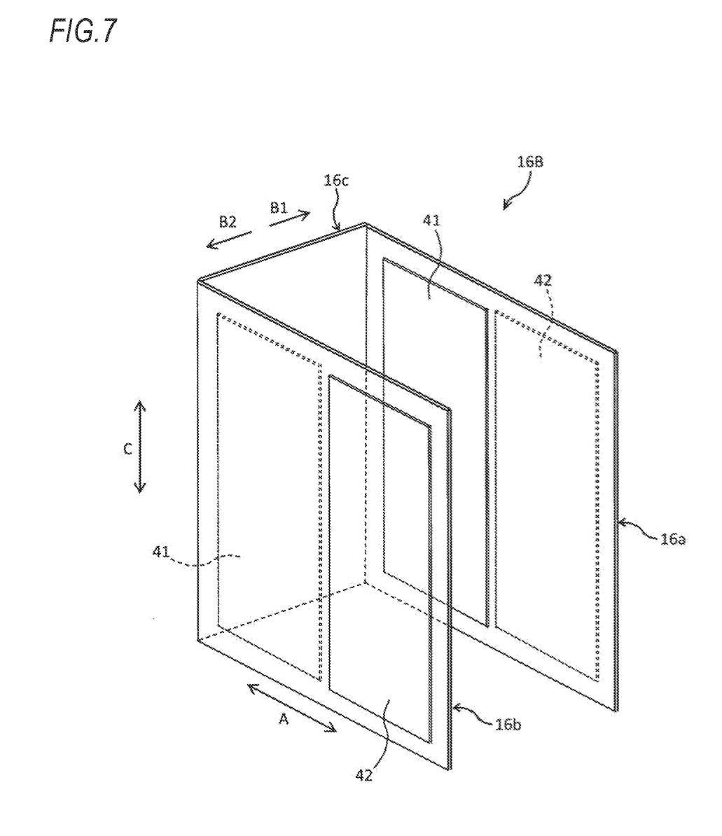

In the insulation paper 16 according to the first embodiment illustrated in FIGS. 2 and 3, when the first insulation portion 16a or the second insulation portion 16b is viewed from the coil 12 inserted into the slot 15, the first adhesive layer 41 and the second adhesive layer 42 partially overlap each other in the radial direction (direction of the arrow A), but may be disposed not to overlap each other as the insulation paper 16B according to the third embodiment illustrated in FIG. 7. Similarly, in the insulation paper 16A according to the second embodiment illustrated in FIGS. 4 and 5, the first adhesive layer 41 and the second adhesive layer 42 may be disposed so as not to overlap with each other in the radial direction. When the first insulation portion 16a or the second insulation portion 16b is viewed from the coil 12 inserted into the slot 15, there is no path along which the vibration from the coil 12 to the teeth 14 propagates directly in the circumferential direction unless the first adhesive layer 41 and the second adhesive layer 42 overlap each other. That is, since there is no propagation path through the adhesive layer, the propagation of vibration can be further suppressed.

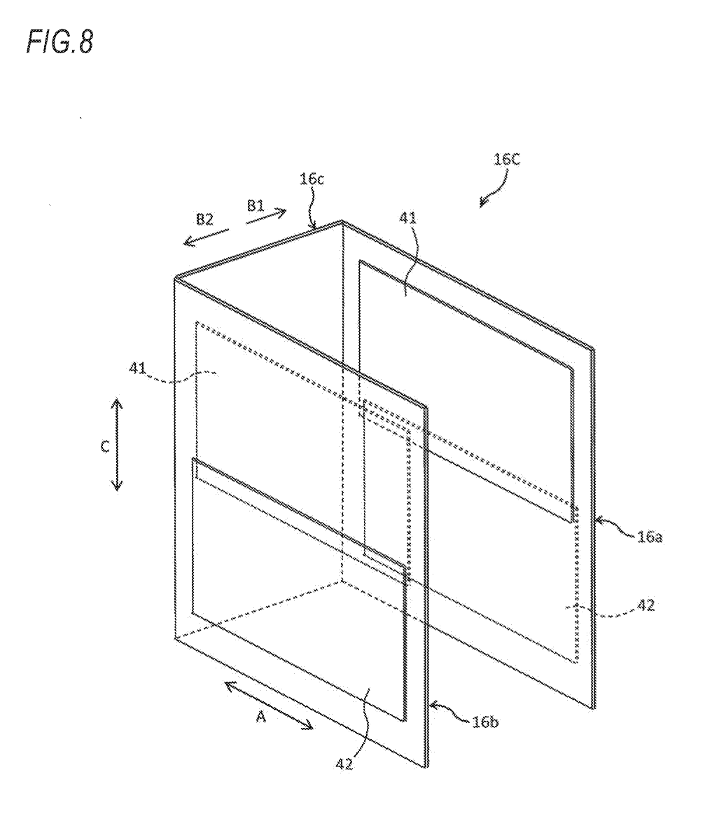

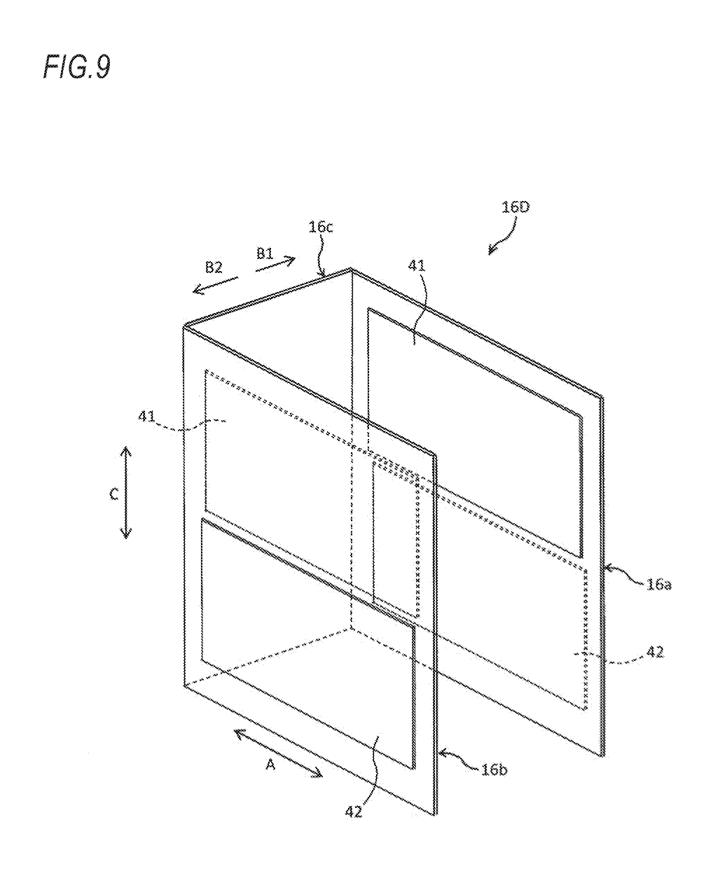

In the insulation papers 16, 16A, 16B according to the embodiments illustrated in FIGS. 2 to 7, when the first insulation portion 16a or the second insulation portion 16b is viewed from the coil 12 inserted into the slot 15, the first adhesive layer 41 and the second adhesive layer 42 are disposed to be displaced from each other in the radial direction (direction of the arrow A). However, as an insulation paper 16C according to a fourth embodiment illustrated in FIG. 8 and an insulation paper 16D according to a fifth embodiment illustrated in FIG. 9, the first adhesive layer 41 and the second adhesive layer 42 each have a rectangular shape in which a side in the radial direction (direction of the arrow A) may be longer than a side in the axial direction (direction of the arrow C), and when the first insulation portion 16a or the second insulation portion 16b is viewed from the coil 12 inserted into the slot 15, the first adhesive layer 41 and the second adhesive layer 42 may be disposed to be displaced from each other in the axial direction (direction of the arrow C). Even in a configuration in which the first adhesive layer 41 and the second adhesive layer 42 are disposed to be displaced from each other in the axial direction, the propagation path of the vibration from the coil 12 to the teeth 14 can be lengthened, so that the propagation of vibration can be suppressed. Incidentally, regardless of the disposition of the first adhesive layer 41 and the second adhesive layer 42 illustrated in FIGS. 8 and 9, an axial positional relationship between the first adhesive layer 41 and the second adhesive layer 42 in the first insulation portion 16a and the axial positional relationship between the first adhesive layer 41 and the second adhesive layer 42 in the second insulation portion 16b may be reversed.

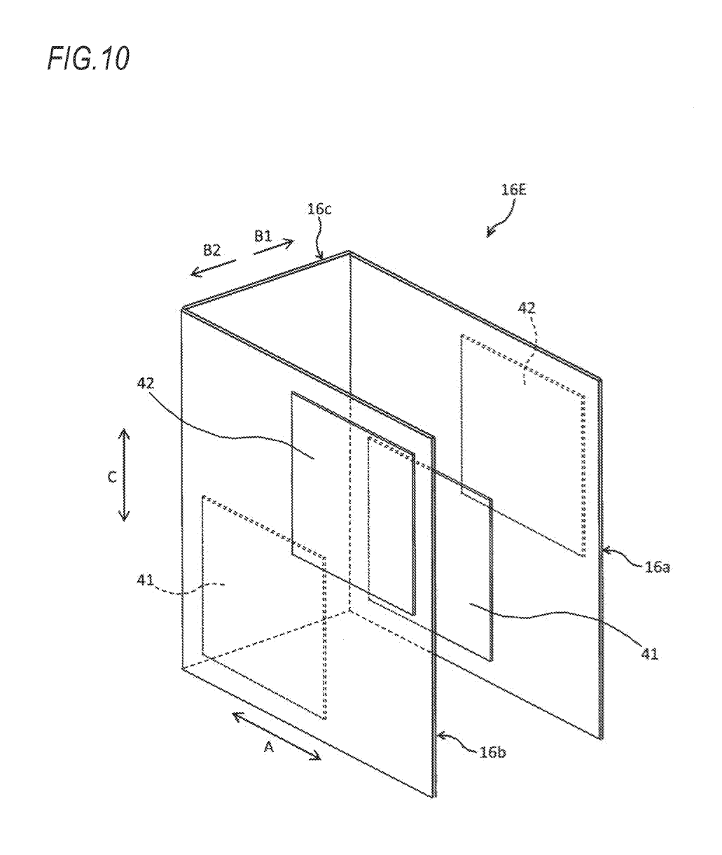

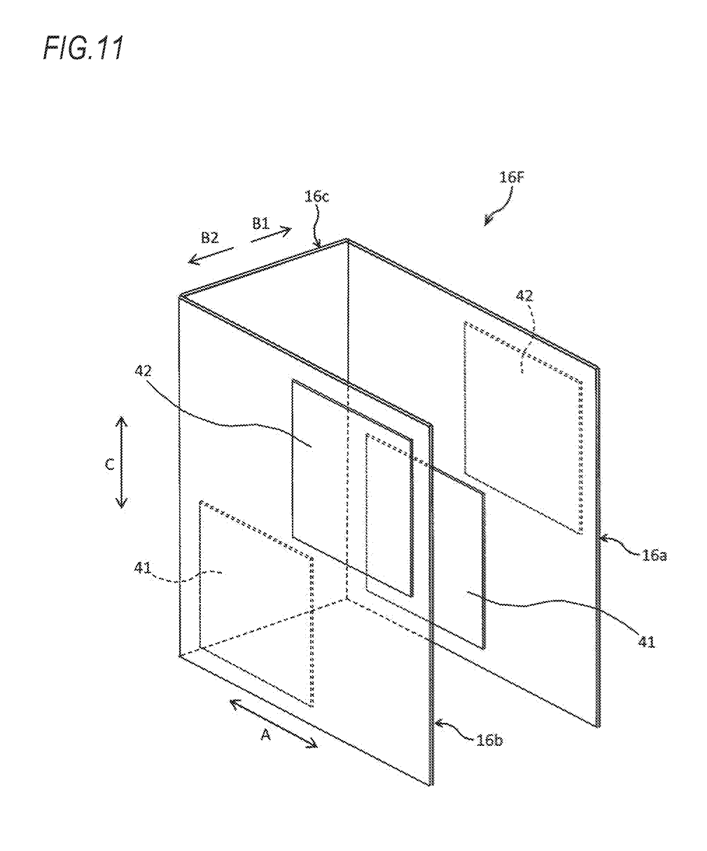

As an insulation paper 16E according to a sixth embodiment illustrated in FIG. 10 and an insulation paper 16F according to a seventh embodiment illustrated in FIG. 11, the first adhesive layer 41 and the second adhesive layer 42 may be disposed to be displaced from each other in the radial direction (direction of the arrow A) and the axial direction (direction of the arrow C), respectively. Since a propagation path of vibration from the coil 12 to the teeth 14 in the insulation paper 16E of the sixth embodiment and the insulation paper 16F of the seventh embodiment is longer than that in the insulation paper 16, 16A, 16B illustrated in FIGS. 2 to 7 and that in the insulation paper 16C, 16D illustrated in FIGS. 8 and 9, the propagation of vibration can be further suppressed. Regardless of the disposition of the first adhesive layer 41 and the second adhesive layer 42 illustrated in FIGS. 10 and 11, the radial positional relationship and/or the axial positional relationship between the first adhesive layer 41 and the second adhesive layer 42 in the first insulation portion 16a and the radial positional relationship and/or the axial positional relationship between the first adhesive layer 41 and the second adhesive layer 42 may be reversed.

Incidentally, the present invention is not limited to the above-described embodiment and may be appropriately modified, improved, or the like.

1. A stator of a rotary electric machine, the stator comprising:
a stator core including a plurality of slots in a circumferential direction thereof;
a coil inserted into each of the slots; and
an insulation paper disposed between each of the slots and the coil,
wherein the insulation paper includes a first adhesive layer provided on one surface of the insulation paper and a second adhesive layer provided on the other surface of the insulation paper, and
wherein the first adhesive layer and the second adhesive layer are disposed to be displaced from each other when the insulation paper located on one side in the circumferential direction is viewed from the coil inserted into the slot.

2. The stator of a rotary electric machine according to claim 1,
wherein the first adhesive layer and the second adhesive layer are disposed not to overlap each other when the insulation paper located on the one side in the circumferential direction is viewed from the coil inserted into the slot.

3. The stator of a rotary electric machine according to claim 1,
wherein the first adhesive layer and the second adhesive layer are disposed to be displaced from each other when the insulation paper located on the other side in the circumferential direction is viewed from the coil inserted into the slot.

4. The stator of a rotary electric machine according to claim 3,
wherein the first adhesive layer and the second adhesive layer are disposed not to overlap each other when the insulation paper located on the other side in the circumferential direction is viewed from the coil inserted into the slot.

5. An insulation paper to be disposed between a slot formed in a stator core and a coil inserted into the slot, the insulation paper comprising:
a first adhesive layer provided on one surface of the insulation paper and a second adhesive layer provided on the other surface of the insulation paper,
wherein the first adhesive layer and the second adhesive layer are disposed to be displaced from each other.

6. The insulation paper according to claim 5,
wherein the first adhesive layer and the second adhesive layer are disposed not to overlap each other.
